(19) United States
(12) Patent Application Publication
(10) Pub. No.: US 2005/0253702 A1
(43) Pub. Date: Nov. 17, 2005

(54) Alarm system, security container and kit

(76) Inventor: John B. Moyer, Meredith, NH (US)

Correspondence Address: Lawson & Persson, P.C., Suite 103, 67 Water Street, Laconia, NH, 03246, US

(21) Appl. No.: 11/127,390

(22) Filed: May 12, 2005

Related U.S. Application Data
(60) Provisional application No. 60/570,705, filed on May 13, 2004.

(51) Int. Cl. G08B 1/08

(52) U.S. Cl. 340/539.11; 340/571

(57) ABSTRACT

An alarm system, security container, and kit. The alarm system includes a base having a top surface, a bottom surface, and an opening therethrough, a rod dimensioned to pass through the opening through the base, and an anchor is attached to the rod and disposed below the bottom surface of the base. An actuator is attached to the rod and disposed above the top surface of the base and a primary switch is attached to the top surface of the base proximate to the actuator. The primary switch includes a switch trigger adapted to communicate with the actuator and turn the primary switch from an off position to an on position when the base is moved upward. A power source is in electrical communication with the switch and an audible alarm in electrical communication with the switch.

### CLAIM OF PRIORITY

This application claims the benefit of priority of U.S. Provisional Patent Application Ser. No. 60/570,705, filed on May 13, 2004.

### FIELD OF THE INVENTION

The present invention relates to the field of security devices and, in particular, to the field of portable security containers.

### BACKGROUND OF THE INVENTION

Time spent on the beach ought to be relaxing. Beaches, however, are often crowded, densely packed public areas enjoyed by hundreds, or even thousands, of people at a single time. The family routine for arriving at the beach is universal: a car pulls into a parking lot; the family digs about the car for possessions needed on the beach, which are frequently small and valuable items such as wallets, cellular phones, car keys, etc., the family strolls with these possessions past groups of other beach-goers to find an open spot amidst the crowd and, ultimately, sets these possessions down on the sand. Unfortunately, once the family's possessions are set down, they cannot be left unwatched for fear of theft. Therefore, at least one person has traditionally been left behind with the possessions, or a responsible member of the family has had to fix a wary eye upon the possessions wherever they are, and whatever they are doing.

It is understandably difficult to relax at the beach while expensive items are distantly strewn about the sand. Accordingly, beachgoers have developed numerous tricks to combat thievery. Current solutions include hiding small items within shoes, larger items under a blanket or towel, or having a friend hold items. Unfortunately, hiding valuables within common, easily stolen items will not stop a determined thief, as even a casual thief would be familiar with such simple ruses.

Some beachgoers have taken to bringing containers that may be locked in order to deter theft. A combination or key lock is the most common means of securing an entry, which is usually a lid or door. The lock certainly increases the difficulty for a thief as s/he attempts to open a lid or door. However, relatively small portable containers may be simply carried away to some distant location, where the lock may be broken or defeated. Therefore, there is a need for a container that includes an alarm that detects unauthorized displacement, instead of solely unauthorized entry

A number of portable anti-theft containers and devices having alarms have been developed and patented. However, each has drawbacks that have prevented their widespread acceptance. For example, U.S. Pat. No. 5,153,561, issued Oct. 6, 1992, titled “Secured Valuable Box for Beach Goers” purports to disclose a container, e.g., case or bag, having an internal compartment with an access opening that is entirely closed with a cover having a clasp that cooperates with a latch of an electronic lock carried on the container. Preferably, the cover carries a keypad on its external surface and the keypad is in circuit to an alarm system that includes a control unit, power supply, motion and/or shock switch, and an audible alarm such as a siren. Most preferably, the power supply comprises one, and preferably a pair of panels of, solar cells that are also located on an external surface of the top cover. The container has one or more handles, which can include a shoulder carrying strap. Preferably the container is formed of a thermally insulating material so that the container also serves as a cooler for beverage cans and the like.

The use of a container having an alarm is a significant advantage, as the attempted theft of the container is readily recognized by surrounding beachgoers as soon as the alarm is triggered. Unfortunately, the use of a shock switch in such a system is a significant impediment to this product's acceptance. Sand is easily moved by people walking past the user's beach site, or by family members lounging or playing around the site, and the motion created by this moving sand is generally sufficient to trigger the alarm. Therefore, there is a need for a portable container that includes an alarm that will not be inadvertently triggered by normal activities conducted around the container. Further, the need to enter a code into the keypad makes this container difficult to disarm should it be inadvertently triggered.

U.S. Pat. No. 5,577,611, issued Nov. 26, 1996, titled “Organizer for Personal Effects” purports to disclose an organizer bag supported on a ground-engaging stand, and provided with a hanging rail or rails. This patent discloses an alarm device located in the base of the organizer with a loop exposed thereunder. A similar loop is provided on a loose rotatable ring located on a spike. A cord attaches to the loop on the organizer and the loop on the spike; tension on the cord pulls downward on the loop, which activates an alarm on the organizer.

Unlike the motion activated alarm of the above mentioned device, the alarm system of this device utilizes a mechanical trigger that will is not susceptible to inadvertent triggering. However, this device also has significant drawbacks. First, the alarm system requires complicated preparation in order to arm it. A cord must be attached between two rings on surfaces: one meant to face the ground; the other meant to be driven within the ground. After placing the cord, it is likely a delicate matter to place the organizer in the sand without setting off the alarm. This is made more difficult given the fact that the spike must be forced into the ground. Second, the tapered spike used to secure the device to the ground is visible to potential thieves and may be easily removed along with the organizer without triggering the alarm. Third, the use of a spike requires that the organizer be used in areas where the spike may penetrate the ground. Therefore, it is not readily adapted for use on hard ground, asphalt, picnic tables or other solid surfaces. Fourth, the organizer has no means for securing valuables such that they may not be easily removed from it without removing the entire organizer from the spike. Finally, this system requires a particular spike/organizer orientation and may not be adapted for use in connection with other containers.

U.S. Pat. No. 6,046,678, issued Apr. 4, 2000, titled “Protective Device for Storage and Transport Containers” purports to disclose a protective device for storage and transport containers which comprises, in accordance with the present invention, a housing or frame carrying a sensor for detecting orientation, an attachment element for securing the housing or frame to a container, an alarm mounted to the housing or frame and operatively coupled to the sensor for generating a cognizable alert signal upon detection by the sensor that the container is in an orientation other than a predetermined preferred orientation, and an activation element mounted to the housing or frame and operatively connected to the sensor and/or the alarm for enabling operation of that component after securing of the housing or frame to the container. The activation element preferably includes a switching component for enabling operation of the alarm only after securing of the housing or frame to the container.

The above transport container is readily adapted for use with a number of containers and uses an orientation sensor to trigger an alarm, which reduces the risk of inadvertent triggering. However, the orientation sensor uses a gravity switch to indicate when the container is not in an upright orientation. As such, the container is meant to protect articles from physical abuse rather than thievery. An alarm system would preferably protect against a container's removal regardless of initial or subsequent orientation.

Therefore, there is a need for a portable container for storing valuable articles that includes an alarm, that is compatible with multiple and various articles, that will not be inadvertently triggered by normal activities conducted around the container, that is simple to disarm should it be inadvertently triggered, that does not require complicated preparation in order to arm the alarm, that is not visible to potential thieves and may not be easily removed along with the container without triggering the alarm, that is readily adapted for use on hard ground, asphalt, picnic tables or other solid surfaces, that secures valuables such that they may not he easily removed from it without removing the entire container, that is readily be adapted for use in connection with a various containers, and that may not be removed by maintaining the container in a particular orientation.

### SUMMARY OF THE INVENTION

The present invention is an alarm system for securing a container, a security container using such an alarm system, and an alarm kit for forming an alarm system.

In its most basic form, the alarm system includes a base having a top surface, a bottom surface, and an Opening therethrough, a rod dimensioned to pass through the opening through the base, and an anchor is attached to the rod and disposed below the bottom surface of the base. The anchor is dimensioned to maintain the rod in a substantially fixed position when the base is moved upward. An actuator is attached to the rod and disposed above the top surface of the base and a primary switch is attached to the top surface of the base proximate to the actuator. The primary switch includes a switch trigger adapted to communicate with the actuator and turn the primary switch from an off position to an on position when the base is moved upward. A power source is in electrical communication with the switch and an audible alarm in electrical communication with the switch.

In operation, when the base is lifted, the anchor maintains the rod in a substantially fixed position, allowing the actuator to cause the switch trigger to change the switch to an on position. This allows power to flow from the power source through the switch and on to the audible alarm, which causes it to emit a sound.

The anchors may take many forms to accommodate the many different applications in which the system may be used. In some embodiments, the anchor is a gravity anchor taking the form of a substantially rectangular metal prism, which may further include a magnet, or magnets, attached thereto. In others the anchor is a magnetic anchor. In still others, it is a helix including a tip and at least one turn. Such anchors may or may not also include a pair of blades attached to, and extending outward from, the rod at a location proximate to the helix. In all embodiments, the rod may be removably attached to the anchor, may be fixedly attached, or may be formed integral thereto.

In one embodiment, the actuator is a collar attached to the rod and the switch trigger is a toggle lever that is dimensioned to contact the collar and mechanically move poles of the primary switch between the off position and the on position when the base is moved upward. The preferred actuator is a wing nut that is attached to a threaded rod that passes through an opening in the toggle lever type switch trigger. In operation, the threaded rod is passed through the opening in the toggle lever and the wing nut threaded downward to contact toggle lever such that the lever is moved downward when the base is moved upward, causing the alarm to be switched on. However, other types of actuators and switches are contemplated and have been discussed below.

In some embodiments, a secondary switch is included and placed in electrical communication with the primary switch and audible alarm. In still others, a housing, attached to the base, is included.

The alarm kit includes all of the components of the alarm system, but includes multiple anchors. The preferred kit is separated into an alarm assembly, which includes the power source, audible alarm and switch, and a rod assembly that includes the rod, actuator and multiple anchors.

The security container of the present invention includes the alarm system and a container having a storage portion within which the alarm system is disposed. In some embodiments, the container includes a storage portion and a lid portion, and the base of the alarm system is the bottom surface of the storage portion of the security container. Other embodiments of the container include a secondary switch in electrical communication with the primary switch and the audible alarm of the alarm system. The preferred container includes a secondary switch and the container also includes a lid portion, a lock, and a light that shows when the alarm is armed. The lock includes a locking arm dimensioned to secure the lid portion of the container in a closed position and an trigger arm dimensioned to engage the switch trigger of the secondary switch and change the secondary switch from an off position to an on position.

In some embodiments, a visible light is attached to the container and is lit when the alarm is armed. This light may remain on or flash intermittently in order to provide an additional warning to potential thieves that the container is protected from theft.

Finally, some embodiments of the security container include a bottom surface to which four feet are disposed and dimensioned to leave a substantially small space between a top of an anchor and the bottom surface of the container.

Therefore, it is an aspect of the present invention to provide an alarm that detects unauthorized displacement, instead of solely unauthorized entry.

It is a further aspect of the present invention to provide a low-cost alarm system.

It is a further aspect of the present invention to provide a highly portable alarm system that is compatible with multiple and various articles.

It is a further aspect of the present invention to provide an alarm system that is compatible with multiple and various containers.

It is a further aspect of the present invention to provide an alarm that is simple to operate.

It is a further aspect of the present invention to provide an alarm that is quickly installed and removed.

It is a further aspect of the present invention to provide a kit having readily interchangeable components.

It is a further aspect of the present invention to provide an alarm system and security container that will not be inadvertently triggered by normal activities conducted around the container.

It is a further aspect of the present invention to provide an alarm system that is simple to disarm should it be inadvertently triggered.

It is a further aspect of the present invention to provide an alarm system and security container that does not require complicated preparation in order to arm the alarm.

It is a further aspect of the present invention to provide an alarm system that is not visible to potential thieves and may not be easily removed along with the security container without triggering the alarm.

It is a further aspect of the present invention to provide an alarm system and security container that is readily adapted for use on hard ground, asphalt, picnic tables or other solid surfaces.

It is a further aspect of the present invention to provide a security container that secures valuables such that they may not be easily removed from it without removing the entire container.

It is a further aspect of the present invention to provide an alarm system that is readily adapted for use in connection with a various containers.

It is a still further aspect of the present invention to provide an alarm system and security container that that may not be removed by maintaining the container in a particular orientation.

These aspects of the invention are not meant to be exclusive and other features, aspects, and advantages of the present invention will be readily apparent to those of ordinary skill in the art when read in conjunction with the following description, and accompanying drawings.

### BRIEF DESCRIPTION OF THE DRAWINGS

FIG. 1A is a side view of the basic embodiment of the alarm system of the present invention in an armed position.

FIG. 1B is a side view of the alarm system of FIG. 1A in an alarm position.

FIG. 2A is a side view of one embodiment of a rod and anchor in which the anchor is a substantially rectangular plate for use with hard flat surfaces

FIG. 2B is a side view of one embodiment of a rod and anchor in which the anchor is a magnet that secures the anchor to magnetic metals.

FIG. 2C is a side view of one embodiment of a rod and anchor in which the anchor is of a helix type for threading into hard ground.

FIG. 2D is a side view of one embodiment of a rod and anchor in which the anchor is the helix type member of FIG. 2C coupled with a pair of blades that extend from the rod for burial within sand or loose ground.

FIG. 3 is side a view of the security container of the present invention in which the front surface of the storage compartment is removed to show the alarm system.

FIG. 4 is an exploded side view of one embodiment of the alarm kit of the present invention.

### DETAILED DESCRIPTION OF THE INVENTION

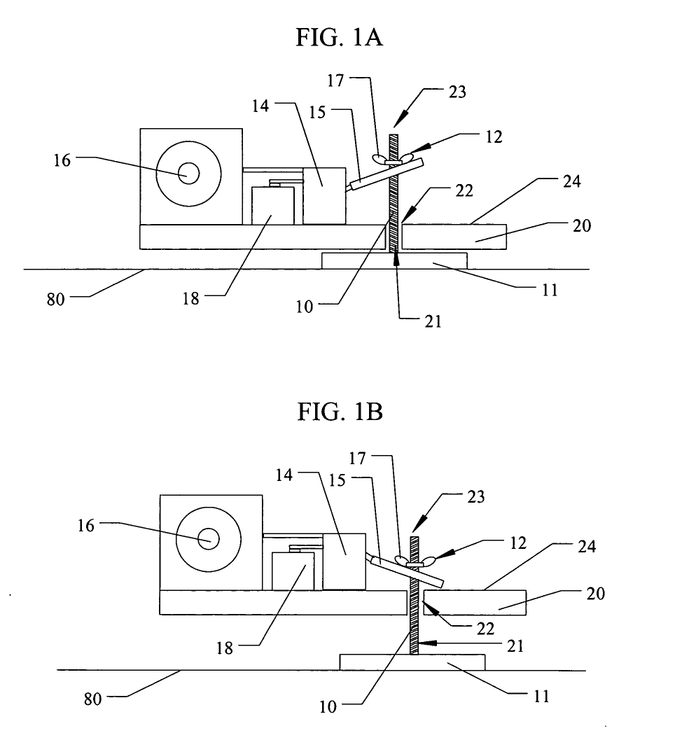

Referring first to FIGS. 1A and 1B, the operation of a basic embodiment of the alarm system 50 is described. The alarm system 50 includes a rod 10, an anchor 11, an actuator 12, a primary switch 14, an audible alarm 16, and a power source 18 and a base 20 to which the primary switch 14, audible alarm 16 and power source 18 are mounted.

The rod 10 is attached to the anchor 11 and extends therefrom through an opening 22 in the base 20. The rod 10 is shown as a substantially cylindrical member, but may take any art recognized shape, such a square, triangular, hexagonal, etc. The preferred rod 10 is a threaded rod manufactured of a metallic material, due to its compatibility with the preferred metal anchors 11. However, it is recognized that plastic, or other types of materials, may be substituted, and the rod 10 should not be seen as being so limited.

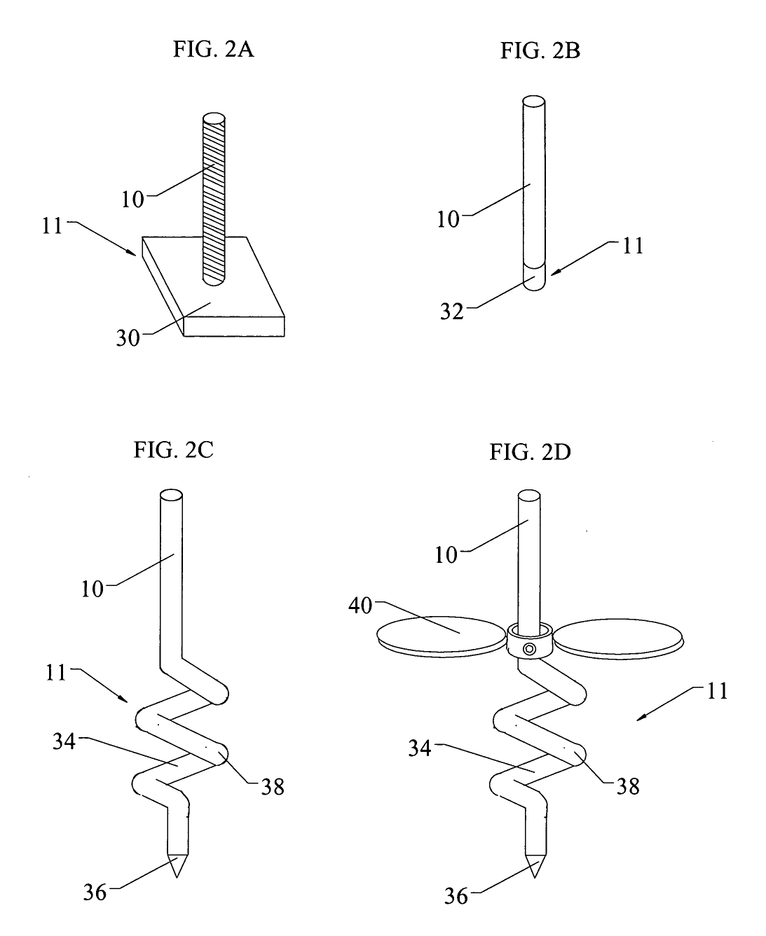

The anchor 11 in the embodiment of FIGS. 1A and 1B, is a weighted anchor 111 that relies upon gravity to hold the anchor 11 and rod 10 in a substantially stationary position relative to the surface 80 on which it is placed. As shown in FIGS. 1A, 1B and 2A, the anchor 11 is merely a block into which the rod 10 is threaded or welded. However, as described in more detail below with reference to FIGS. 2B-2D, the anchor 111 may take many forms and is adapted to maintain the rod 10 in a substantially fixed position when the base 20 is moved upward.

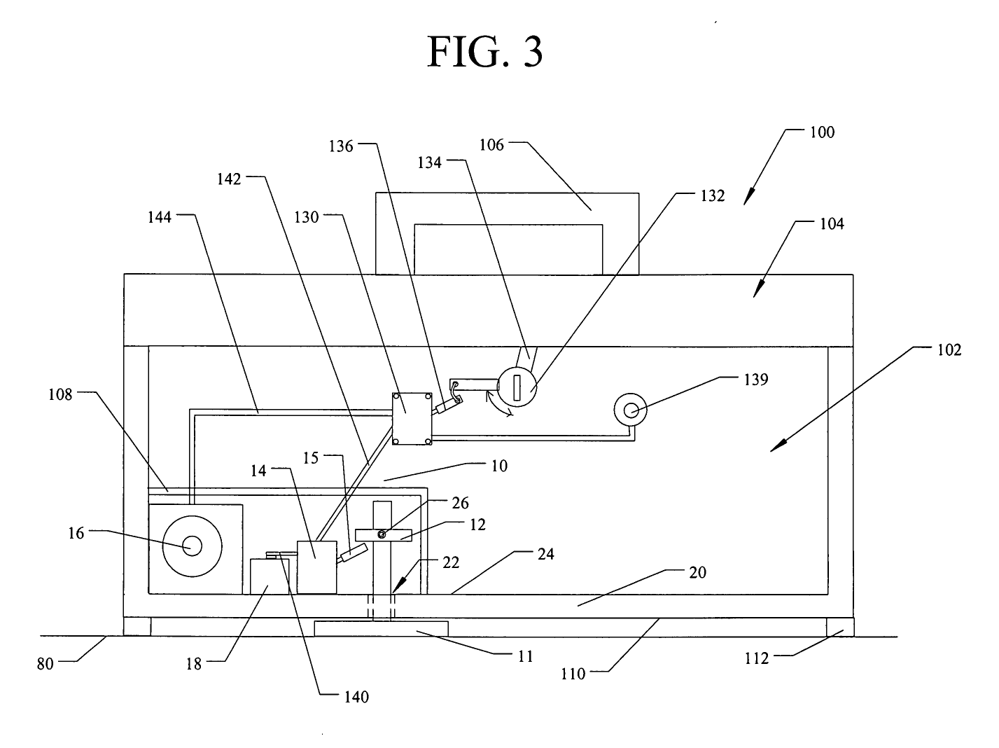

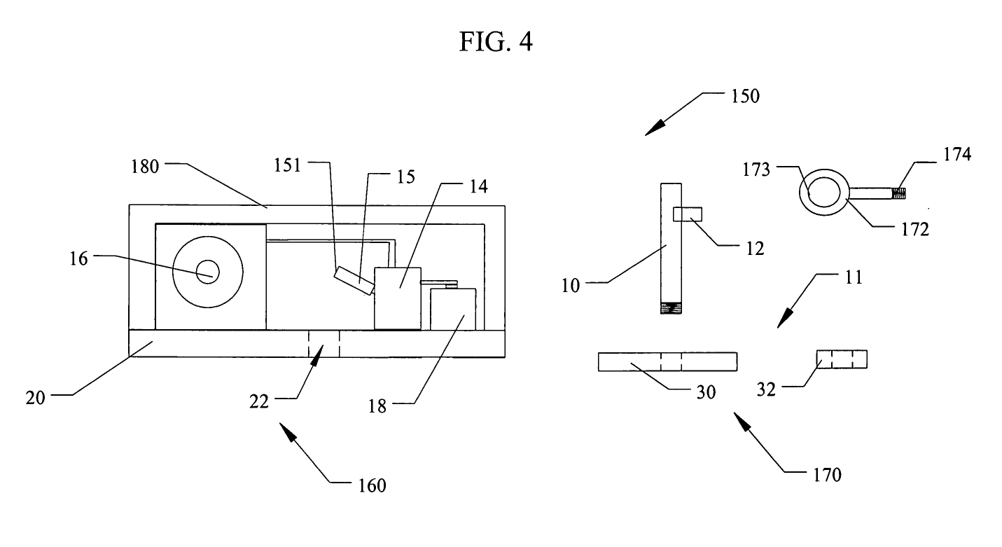

The actuator 12 is attached to the rod 10 at a point above the top surface 24 of the base 20 such that the base 24 may move upward without immediately interfering with the actuator 12. The preferred actuator 12 of FIGS. 1A and 1B is a wing nut 17 that threaded onto the rod 10. However, it is recognized that the actuator 12 may also take many forms including, but not limited to, a metal collar that is attached to the rod 10 via a setscrew 26, as shown in FIG. 3, an eyebolt 172 and second rod, as shown in FIG. 4, or metal clothespin type clips (not shown) that are removably attached to the rod 10. The actuator 12 is dimensioned and adapted to cause a switch trigger 15, which forms part of the primary switch 14, to move from an “off” position to an “on” position when the base 20 is moved upward.

As shown in FIGS. 1A and 1B, the switch trigger 15 is a finger or toggle lever that mechanically moves the poles of the primary switch 14 between an “on” and an “off” position. In the preferred embodiment of FIGS. 1A and 1B, the switch trigger 15 includes an opening that is dimensioned to allow the rod 10 to pass therethrough, after which the wing nut 17 is threaded onto the rod 10 such that it contacts the switch trigger 15. Once the actuator 12 moves the switch trigger 15 to the alarm position, power is allowed to flow from the power source 18 through the primary switch 14 to energize the audible alarm 16, causing it to emit a loud sound that is easily heard by people in the vicinity of the alarm system 50. However, as explained below, a number of different types of switches may be utilized to achieve similar results. For example, in an alternate embodiment, the primary switch 14 is a proximity switch, similar to those used on window and door alarms, and the actuator 12 is an electrical contact disposed upon, or within, the rod 10 that forms a circuit with the primary switch 14 when aligned therewith. As this circuit is either broken or completed, the primary switch 14 would switch from an “off” position to an “on” position, allowing power to flow to the audible alarm 16 in a manner similar to that discussed above.

The power source 18 is preferably a 9-volt battery, such as those used in smoke detectors, and is attached in series with the alarm 16 through the primary switch 14. However, those of ordinary skill in the electrical-mechanical arts would readily recognize that other power sources 18 and wiring arrangements may be substituted to achieve similar results.

Operation of the basic embodiment of the alarm system 50 is shown in FIGS. 1A and 1B. For ease of explanation, the container (not shown) has been omitted from these figures. However, it should be recognized that the alarm system 50 would typically be inserted within a container having an opening therein and such that the opening 22 in the base 20 is aligned with a similarly sized opening in the container, or the alarm system 50 would be formed as an integral part of a container, in which case the base 20 would be the bottom surface of the container. Regardless of how the alarm system 50 and container are integrated, the opening 20 must allow the anchor 11 to be disposed outside of the container while the rod 10 extends into the container.

In FIG. 1A, the alarm system 50 is an “off position” in which the switch trigger 15 is disposed upward, the actuator 12 is slightly above the switch trigger 15, and the anchor 11 is sandwiched between a surface 80 and the bottom of base 20. When the container is lifted, the base 20 is also lifted, causing the switch trigger 15 to contact the actuator 12. Because the anchor 11 maintains the rod 10, and hence the actuator 12, in a substantially fixed position, the further movement of the base 20 causes the switch trigger 15 to rotate downward to the position shown in FIG. 1B. As noted above, when the switch trigger 15 is in this “on” position, the primary switch 14 allows power to flow from the power source 18 to the audible alarm 16, causing it to emit a loud sound that is easily heard by people in the vicinity of the alarm system 50.

Referring now to FIGS. 2A-2D, a series of embodiments of the rod 10 and anchor 111 are shown. In FIG. 2A, the anchor 11 is the same rectangular block 30 as shown in FIGS. 1A and 1B, which may be referred to as a gravity anchor, and the rod 10 is the preferred threaded rod 10 shown in FIGS. 1A and 1B. This block 30 is preferably manufactured Or a metal material, such as steel, having a relatively high density to allow it to weigh enough to prevent it from lifting from the ground when the container is lifted. However, it is recognized that blocks 30 manufactured of less dense materials, such as plastics, may also be used in connection with weighted inserts, provided the overall weight of the block is sufficient to prevent it from lifting before the switch is actuated. Although a substantially rectangular block 30 is shown, it is also recognized that blocks 30 of other shapes and sizes may be substituted to achieve similar results. Given a heavy enough material, the shape of the gravity slip rod 110 becomes less important; i.e. a perfectly cylindrical rod of gold would suffice, while a gravity slip rod constructed of plastic would probably require a disproportionate base to supply the needed weight. As is the case with all of the embodiments of FIGS. 2A-2D, the rod 10 may be attached to the anchor 11 in a variety of art-recognized manners. For example, the rod 10 may mate with a female threaded bore within the block 30, allowing it to be disassembled and reassembled. However, the rod 10 and block 30 may also be forged or cast in a single operation, or formed separately and welded, press fit, other otherwise fixedly attached together. Finally, it is noted that the rectangular block 30 may be made of thinner cross section and substituted for the blades 40 of the embodiment of FIG. 2D in applications where the anchor 11 is to be buried within sand or loose soil.

FIG. 2B shows a rod 10 and anchor 11 in which the anchor 11 is a magnet 32. This embodiment is adapted for use in applications where the alarm system is placed on surfaces, such as shelves in lockers, which are manufactured of ferrous metals, or other magnetic materials. As shown in FIG. 2B, the magnet may be of a size and shape similar to that of the rod 10, provided such a magnet 32 is sufficiently strong to allow the alarm to be triggered when the base is lifted. Because the magnet 32 exerts a magnetic force upon the rod 10 to keep it in a substantially fixed position, there is no need to include a heavy block, such as the block 30 of the embodiment of FIG. 2A, to attach to the rod 10. However, in some embodiments, the magnet 32 is, or multiple magnets are, attached to the bottom of a block 30, allowing a single anchor 11 to serve both in magnetic and weight based applications.

FIG. 2C shows a rod 10 and anchor 11 in which the anchor 11 is a helix 34, similar to a corkscrew or auger. This embodiment is adapted for use in applications where the alarm system is placed on surfaces, such as grass, compacted gravel, or the like, that are relatively compacted but may be readily pierced by the tip 36 of such a helix 34. In this embodiment, the tip 36 of the helix 34 is pushed downward to pierce the surface and the helix 36 is rotated such that the turns 38 of the helix 34 continue to move down and are captured below the surface. In this manner, the force of the soil, gravel, etc., upon the turns 38 of the helix 34 resists upward movement, maintaining the rod in a substantially fixed position. In the embodiment of FIG. 2C, the helix 34 is shown as a unitary structure formed integral to the rod 10, which is preferred. However, the rod 10 may be attached to the helix 34 by threading, clips, or other art-recognized means for removably attaching two such pieces.

FIG. 2D shows a variation of the rod 10 with a helix 34 as its anchor 11 in which the anchor 11 also includes a pair of blades 40, which extends outward from the rod 10 proximate to the helix 34. This embodiment is especially adapted for use on loose surfaces, such as sand or loose soil, in which the surrounding sand does not provide sufficient downward force on the helix 34 to hold the rod 10 in place. In these embodiments, a small hole is dug and the helix 34 is threaded into the bottom of the hole until the blades 40 come in contact with the bottom.

The sand or soil is then backfilled over the blades 40 such that the additional downward force of the sand or soil on the blades causes the rod 10 to be held in a substantially fixed position.

As shown in FIG. 2D, the blades 40 are removably attached to the rod 10 via a collar 42 and setscrew 44. This allows the blades 40 to be positioned about the rod 10, or near the tip 36 of the anchor 11. However, the blades 40 may be formed integral to the rod 10 or helix 34, or may be removably attached via other art recognized means at either location to achieve similar results.

Referring now to FIG. 3, an embodiment of the security container 100 of the present invention is shown. The security container 100 of FIG. 3 is a rectangular cuboid having a storage portion 102 and a hinged lid portion 104 having a handle 106 extending therefrom.

The container 100 of FIG. 3 is similar in many respects to a conventional tackle or toolbox and may be made from any material, such as plastics or sheet metal, from which these boxes are typically manufactured. However, it is likewise recognized that containers manufactured of fabrics, leather, or other substantially flexible materials may be used, provided there is a base 20 upon which to mount the alarm system 50.

A housing 108 is preferably formed inside the container 100 to isolate the alarm system 50 from the articles to be stored and protect it from damage therefrom. This housing 108 may likewise be formed from a number of materials and be integral, or removably attached, to the bottom surface 124 of the container. In all embodiments, it is necessary that the housing 108 be accessible so that the power source 18 may be refreshed and so that different rods 10 may be attached.

In the embodiment of FIG. 3, the bottom of the container 100 forms the base 20 upon which the alarm 16, power source 18 and switch are mounted and includes an opening 22 therethrough. However, as noted above, the base 20 may be a separate member that is aligned with the bottom of the container 100. The alarm system 50 of this embodiment utilizes a rod 10 with a rectangular anchor 11, similar to those shown in FIGS. 1A, 1B and 2A. Accordingly, it is preferred that the bottom surface 110 of the base 20 include four feet 112 that are sized to provide a small space between the bottom surface 110 and the anchor 11. This small space acts to hide the anchor, making it less conspicuous, while preventing inadvertent triggering due to rocking of the container relative to the anchor. However, in embodiments utilizing the magnetic anchor 11 of FIG. 2B, or either helix type anchors 11 of FIGS. 2C and 2D, these feet 112 are neither necessary nor preferred.

The alarm system 50 of the embodiment of FIG. 3 differs from those described with reference to FIGS. 1A and 1B insofar as they include a secondary switch 130 to allow the alarm system 50 to be activated or deactivated without opening the lid portion 104 of the container 100. In this embodiment, the secondary switch 130 is similar in operation to the primary switch 14 of the alarm system 50 and is attached to the inside of the container 100 proximate to a lock 132. Lock 132 is preferably a key operated lock having a locking arm 134 that engages a mating detail (not shown) in the lid portion 104 to secure the lid portion 104 in a closed position, and a trigger arm 136 that engages the switch trigger 131 of the secondary switch 130.

As shown in FIG. 3, the switch trigger 131 is attached to the trigger arm 136 via a wire 138, which pulls the trigger arm 136 into an alarm position when the lock 132 is engaged. In this position, power flows from the primary switch 14 through second wire 142 to the secondary switch 130 and is allowed to pass through third wire 144 to the alarm 16. When the lock 132 is rotated to a disengaged position, the trigger arm 138 contacts the switch trigger 131 and pushes it downward to an off position, effectively stopping any flow of power to the alarm 16. It is recognized that this arrangement may be readily reversed, or that other types of external on/off systems may be substituted to achieve similar results. In addition, it is recognized that an on/off system may be readily placed inside of the container 100 and accessed by opening the lid portion 104. Finally, it is also envisioned that a the secondary switch 130 may be a remote controlled switch that is activated and deactivated by a small remote control, similar to those currently used in connection with automotive or garage doors. Accordingly, the security container 100 should not be seen as being limited to the embodiment shown in, and described with reference to, FIG. 3.

FIG. 3 also shows a light 139, which is attached to the side of the container 100. The light is in electrical communication with the power source 18 and is activated when the alarm is armed. The light 139 may remain on, or may be adapted to flash intermittently in order to provide an additional warning to potential thieves that the container is protected from theft.

It is envisioned the that alarm system 50 will be sold in kit form, which would include two or more anchors 11 to allow the system 50 to be used in varying conditions. As noted above, the ability to use the system 50 in varying conditions is an important advantage of the present invention.

As shown in FIG. 4, it is envisioned that the kit 150 will include an alarm assembly 160 made up of the base 20, power source 18, audible alarm 16 and switch 14, and a rod assembly 170 made up of the rod 10, actuator 12 and anchors 11. The alarm system 160 may include a full housing 180, or may simply include the base 20 without any additional housing to protect the components.

As shown in FIG. 4, the actuator 12 is not a collar or wing nut 17, but rather is another rod, or other extension that is attached to the rod 10 via threading, welding, or other attachment means. The embodiment of FIG. 4 also includes an eyebolt 172, which includes an eye opening 173 that is dimensioned to slip over the rod 10 and a threaded portion that threads into a threaded opening (not shown) in the end 151 of the switch trigger 15. In operation, the actuator 12 will contact the eyebolt 172 and cause it to be triggered in the same manner as described above. It is noted that the alternative actuator 12 and eyebolt 172 are shown with reference to the kit 150, but may be utilized with other embodiments of the invention to achieve similar results.

As shown in FIG. 4, a single threaded rod 10 is provided and is used in connection with the gravity anchor 30 and magnet 32 shown therein. However, other embodiments may include additional or substituted anchors 11, and/or include separate rods 10 that are fixedly attached to each anchor 11. Accordingly, the invention should not be seen as being so limited.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

1. An alarm system comprising:
a base comprising a top surface, a bottom surface, and an opening therethrough;
a rod dimensioned to pass through said opening through said base;
an anchor attached to said rod and disposed below said bottom surface of said base, said anchor being dimensioned to maintain said rod in a substantially fixed position when said base is moved upward;
an actuator attached to said rod and disposed above said top surface of said base;
a primary switch attached to said top surface of said base proximate to said actuator, wherein said primary switch comprises a switch trigger adapted to communicate with said actuator and turn said primary switch from an off position to an on position when said base is moved upward;
a power source in electrical communication with said switch; and
an audible alarm in electrical communication with said switch.

2. The alarm system as claimed in claim 1 wherein said anchor is a gravity anchor.

3. The alarm system as claimed in claim 2 wherein said gravity anchor comprises a substantially rectangular metal prism.

4. The alarm system as claimed in claim 3 wherein said gravity anchor further comprises at least one magnet.

5. The alarm system as claimed in claim 1 wherein said anchor is a magnetic anchor.

6. The alarm system as claimed in claim 1 wherein said anchor comprises a helix comprising a tip and at least one turn.

7. The alarm system as claimed in claim 6 wherein said anchor further comprises a pair of blades and wherein said blades are attached to, and extend outward from, said rod at a location proximate to said helix.

8. The alarm system as claimed in claim 1 wherein said rod is removably attached to said anchor.

9. The alarm system as claimed in claim 1 wherein said actuator comprises a nut threaded upon said rod and wherein said switch trigger is a toggle lever that is dimensioned to allow said rod to pass therethrough and to contact said nut to mechanically move poles of said primary switch between said off position and said on position when said base is moved upward.

10. The alarm system as claimed in claim 1 further comprising a secondary switch in electrical communication with said primary switch and said audible alarm.

11. The alarm system as claimed in claim 1 further comprising a housing attached to said base.

12. An alarm kit for forming an alarm system, said alarm kit comprising:
a base comprising a top surface, a bottom surface, and an opening therethrough;
at least one rod dimensioned to pass through said opening through said base;
at least two anchors dimensioned for attachment to said at least one rod and disposal below said bottom surface of said base, wherein each of said at least two anchors is dimensioned to maintain said rod in a substantially fixed position when said base is moved upward;
an actuator dimensioned for attachment to said rod and disposed above said top surface of said base;
a primary switch attached to said top surface of said base proximate to said actuator, wherein said primary switch comprises a switch trigger adapted to communicate with said actuator and turn said primary switch from an off position to an on position when said base is moved upward;
a power source in electrical communication with said switch; and
an audible alarm in electrical communication with said switch.

13. The kit as claimed in claim 12 wherein said at least two anchors are chosen from a group consisting of a gravity anchor, a magnetic anchor and a helix anchor.

14. The kit as claimed in claim 12 wherein said at least one rod is dimensioned for removable attachment to said anchor.

15. The kit as claimed in claim 12 wherein said at least one rod comprises at least two rods and wherein one of said at least two rods is fixedly attached to each of said at least two anchors.

16. A security container comprising:
an alarm system comprising:
a base comprising a top surface, a bottom surface, and an opening therethrough;
a rod dimensioned to pass through said opening through said base;
an anchor attached to said rod and disposed below said bottom surface of said base, said anchor being dimensioned to maintain said rod in a substantially fixed position when said base is moved upward;
an actuator attached to said rod and disposed above said top surface of said base;
a primary switch attached to said top surface of said base proximate to said actuator, wherein said primary switch comprises a switch trigger adapted to communicate with said actuator and turn said primary switch from an off position to an on position when said base is moved upward;
a power source in electrical communication with said switch; and
an audible alarm in electrical communication with said switch; and
a container comprising a storage portion within which said alarm system is disposed.

17. The security container as claimed in claim 16 wherein said container comprises a storage portion and a lid portion and wherein said base of said alarm system comprises a bottom surface of said storage portion of said security container.

18. The security container as claimed in claim 16 further comprising a secondary switch in electrical communication with said primary switch and said audible alarm of said alarm system.

19. The security container as claimed in claim 18 wherein said secondary switch comprising a switch trigger and wherein said container further comprises a lid portion and a lock, said lock comprising a locking arm dimensioned to secure said lid portion of said container in a closed position and an trigger arm dimensioned to engage said switch trigger of said secondary switch and change said secondary switch from an off position to an on position.

20. The security container as claimed in claim 16 wherein said container comprises a bottom surface to which four feet are disposed, wherein said feet are dimensioned to leave a substantially small space between a top of an anchor and said bottom surface of said container.
